(19) United States
(12) Patent Application Publication
(10) Pub. No.: US 2017/0001101 A1
(43) Pub. Date: Jan. 5, 2017

(54) SHOOTING SYSTEM, GUN, AND DATA PROCESSING DEVICE

(71) Applicant: MARUZEN COMPANY LIMITED, Tokyo (JP)

(72) Inventor: Yoshiki TOKITA, Kanagawa (JP)

(21) Appl. No.: 15/125,722

(22) PCT Filed: Mar. 13, 2015
(86) PCT No.: PCT/JP2015/057393

§ 371 Date: Sep. 13, 2016

(30) Foreign Application Priority Data
Mar. 13, 2014 (JP) 2014-050644

(51) Int. Cl. A63F 9/02; G09B 9/00; F41J 5/08; G09B 5/00; F41G 3/26; F41J 2/02

(52) U.S. Cl. CPC A63F 9/0291; F41G 3/2605; F41J 2/02; F41J 5/08; F41G 3/2661; G09B 5/00; G09B 9/00; A63F 9/0204; A63F 2250/1036

(57) ABSTRACT

A shooting system including a target, a gun, and a data processing device is provided. The target includes two or more infrared LEDs, the gun has image capturing means for capturing an image of the target via a visible light cutoff filter provided in its gun barrel while including a switch which operates in conjunction with movement of a trigger and transmission control means for transmitting image data acquired by the image capturing means when this switch operates, and the data processing device includes receiving means for receiving the image data sent from the transmission control means in the gun, calculation means for detecting a light spot position of each of the infrared LEDs from the image data and calculating a distance from the gun to the target and a bullet landing position on the target based on the light spot position, and display means for displaying a result of the calculation.

### TECHNICAL FIELD

The present invention relates to a shooting system for conducting shooting, using a target equipped with an LED (Light Emitting Diode) (light emitting element) and a gun on which a camera is mounted, and particularly to a shooting system, a gun and a data processing device that can be utilized as a shooting training or a shooting game in addition to a shooting match using no real bullets.

### BACKGROUND ART

Conventionally, as a technique used for a shooting match and a shooting training conducted without using real bullets, a system for irradiating a laser beam from a gun and receiving this laser beam by a light receiving device installed on the side of a target or at a position spaced apart from the target to calculate a position where the laser beam has hit the target (a bullet landing position) has been proposed. (see, e.g., Patent Documents 1 to 3).

A system for preparing a target having an image of a characteristic shape or the like (a feature image) displayed thereon, capturing the image of the target using a camera provided in a gun, and detecting the position of the feature image within the captured image by pattern matching with a template image previously stored, to calculate a bullet landing position is also proposed. (see, e.g., Patent Documents 4 and 5).

### CITATION LIST

### Patent Document

Patent Document 1: Japanese Unexamined Patent Application Publication No. 2002-318096
Patent Document 2: Japanese Unexamined Patent Application Publication No. 2006-207975
Patent Document 3: Japanese Unexamined Patent Application Publication No. 2006-207976
Patent Document 4: Japanese Unexamined Patent Application Publication No. 2010-259589
Patent Document 5: Japanese Unexamined Patent Application Publication No. 2012-13284

### SUMMARY OF THE INVENTION

### Problem to be Solved by the Invention

However, in the aforementioned systems discussed in Patent Documents 1 to 3, a camera must be installed on the side of the target or must be installed at another location. Therefore, preparation for installation or the like becomes complicated. Also, as a laser beam is used, safety of handling or the like becomes a problem. Further, cost of building the device also increases.

The systems discussed in Patent Documents 4 and 5 presuppose that the feature image is used to find a central position of the captured image. Therefore, a target for a normal match having few feature points cannot be used. The system is affected by environment light when used outdoors so that the recognition rate of the feature image is significantly lowered, which is not practical. Further, in this system, a distance from the gun (i.e., the camera) to the target changes depending on a standing position of a player and the length of his/her arm, the shake of the gun, or the like. A variation in this distance results in a decreased calculation accuracy of the bullet landing position.

The present invention has been made in view of the aforementioned problems, and is directed to implementing a shooting system capable of detecting the center of a target with high accuracy by eliminating the influence of environment light without requiring a laser requiring careful handling and display of a feature image on the target and calculating a bullet landing position with high accuracy even if a distance between a gun and the target has varied, the gun, and a data processing device.

### Means for Solving Problems

To attain the aforementioned object, a shooting system (1) according to the present invention includes

a target (2) including two or more infrared light emitting means (3),

a gun (10) having image capturing means (24) for capturing an image of the target via a visible light cutoff filter (23) serving as means for suppressing the whole or apart of a visible light wavelength region provided in its gun barrel (11), and further including a switch (25) which operates in conjunction with movement of a trigger (14) and transmission control means (26) for transmitting image data acquired by the image capturing means when the switch operates, and

a data processing device (50) including receiving means (53) for receiving the image data sent from the transmission control means, calculation means (51) for detecting a light spot position of each of the infrared light emitting means from the image data and calculating a distance from the gun to the target and a bullet landing position on the target based on the light spot position, and display means (52) for displaying a result of the calculation.

In the present invention, the target is provided with the infrared light emitting means, an image of light from this infrared light emitting means is captured via the visible light cutoff filter, to eliminate the influence of environment light. When the visible light cutoff filter and the image capturing means are provided while their respective central axes are made to match each other in the gun barrel, a location aimed at by a shooter can be accurately identified. A telephotographic lens may be mounted on a front stage of the visible light cutoff filter (on the side of a gun muzzle) in the gun barrel, as needed.

When the target is a target having a concentric score region, the infrared light emitting means is arranged at the center of the target (usually, a region where the highest score is obtained), the infrared light emitting means are further respectively arranged on both sides with the infrared light emitting means at the center sandwiched therebetween on a virtual straight line passing through the center of the target, and the calculation means preferably determines that the light spot position of the infrared light emitting means at the center among the detected respective light spot positions of the infrared light emitting means is the center of the target, calculates the distance from the gun to the target based on a spacing between the light spot positions of either two of the infrared light emitting means, and calculates the bullet landing position based on the distance and a result of the determination. As a result, the center of the target can be detected with high accuracy, and the distance to the target and the bullet landing position can be quickly found by suppressing a processing load in the calculation means. The respective light spots of the infrared light emitting means are preferably detected using an image captured at the same exposure timing. Thus, the influence of environment light can be effectively eliminated.

The calculation means in the shooting system according to the present invention corrects a height direction of the bullet landing position based on the result of the calculation of the distance from the gun to the target. In the present invention, a rear site of the gun need not be readjusted depending on a difference in the distance during a shooting training, for example, resulting in improved convenience for a user. The bullet landing position close to that in live-firing can also be calculated.

Preferably, if the switch in the gun operates by being pressed by a bullet, a firing pin, or a striker which moves when a trigger is pulled, a match or a training can be conducted with a sense close to that in live-firing.

If the target is optically enlarged using the telephotographic lens to capture an image of the target, the calculation means includes a distance correspondence table representing a correspondence relationship between the distance from the gun to the target and the spacing between the light spots of the two different infrared light emitting means. The calculation means can find the distance with high accuracy and quickly when it calculates the distance from the gun to the target by referring to the distance correspondence table. Particularly when the distance between the gun and the target is 10 m or less, the distance is preferably calculated using the distance correspondence table.

While the calculation means has been described above as being provided in the data processing device different from the gun, the calculation means may be composed of a microcomputer and incorporated into the gun. In this case, only a calculation result of the distance from the gun to the target, the bullet landing position, or the like may be sent from the gun to the display means so that a transmission load can be reduced.

A gun (10) according to the present invention particularly has image capturing means (24), which captures an image of a target including infrared light emitting means (3) via a visible light cutoff filter (23), provided in its gun barrel (11), and further includes a switch (25) which operates in conjunction with movement of a trigger (14), and means (26, 51) for generating transmission data for displaying a bullet landing position on the target on display means (52) based on a light spot position of the infrared light emitting means in image data acquired by the image capturing means when the switch operates. Preferably, this gun may include a memory storing a threshold value for binarizing the image acquired by the image capturing means to black and white, and the means for generating the transmission data may generate the image, which has been binarized to black and white based on the threshold value, as the transmission data.

A data processing device (50) according to the present invention includes detecting, from image data of a target including two or more infrared light emitting means (3) and acquired by image capturing means (24) in a gun (10), alight spot position of each of the infrared light emitting means, and calculating a distance from a gun to a target and a bullet landing position on the target based on the light spot position.

### Advantageous Effects of the Invention

As described above, according to the present invention, a laser and real bullets are not used. Therefore, a shooting match and a shooting trailing can be conducted safely and at low cost. The present invention can also be utilized as a shooting toy and a shooting game.

Infrared light emitting means is used as a target, and an image of the target is captured via a visible light cutoff filter which transmits only infrared rays on the side of a gun. Thus, a position of the infrared light emitting means can be correctly detected by eliminating the influence of environment light. Therefore, a bullet landing position can be calculated with high accuracy.

### BRIEF DESCRIPTION OF THE DRAWINGS

FIG. 1 is an entire configuration diagram of a shooting system 1 according to an embodiment of the present invention.

FIG. 2 is an explanatory diagram of an arrangement of LEDs on a target illustrated in FIG. 1.

FIG. 3 is a functional block diagram of a gun illustrated in FIG. 1.

FIG. 4 is a detailed functional block diagram of image capturing means and transmission control means illustrated in FIG. 3.

FIG. 5 is an explanatory diagram of image data processed by calculation means 51 illustrated in FIG. 1.

FIG. 6 is an explanatory diagram of a search range in image data.

FIG. 7 is an explanatory diagram of a distance correspondence table stored in the calculation means 51 illustrated in FIG. 1.

FIG. 8 is an explanatory diagram of a relationship between a distance between respective light spots of LEDs in image data and a distance from a gun to a target.

FIG. 9 is an explanatory diagram of a screen of a calculation result displayed on display means illustrated in FIG. 1.

FIG. 10 is an explanatory diagram of a height correction table in calculation means 51.

FIG. 11 is an explanatory diagram of image data acquired by taking an environment light measure according to an example of the present invention, where FIG. 11(a) is an explanatory diagram illustrating a state where an image is captured outdoors and FIG. 11(b) is an explanatory diagram illustrating a state where an image is captured indoors.

FIG. 12 is an explanatory diagram illustrating the appearance of a target according to another example of the present invention.

FIG. 13 is an explanatory diagram of image data acquired by taking an environment light measure according to the other example of the present invention, where FIG. 13(a) is an explanatory diagram illustrating a state where an image is captured outdoors and FIG. 13(b) is an explanatory diagram illustrating a state where an image is captured indoors.

FIG. 14 is an explanatory diagram of an example of a configuration of a firing mechanism illustrated in FIG. 3 and an operation of a switch 25.

FIG. 15 is an explanatory diagram of another example of a configuration of the firing mechanism illustrated in FIG. 3 and an operation of the switch 25.

FIG. 16 is an explanatory diagram of calculation processing for height correction by the calculation means 51.

FIG. 17 is an entire configuration diagram of a shooting system 1 according to another example.

FIG. 18 is a functional block diagram of a gun according to another example.

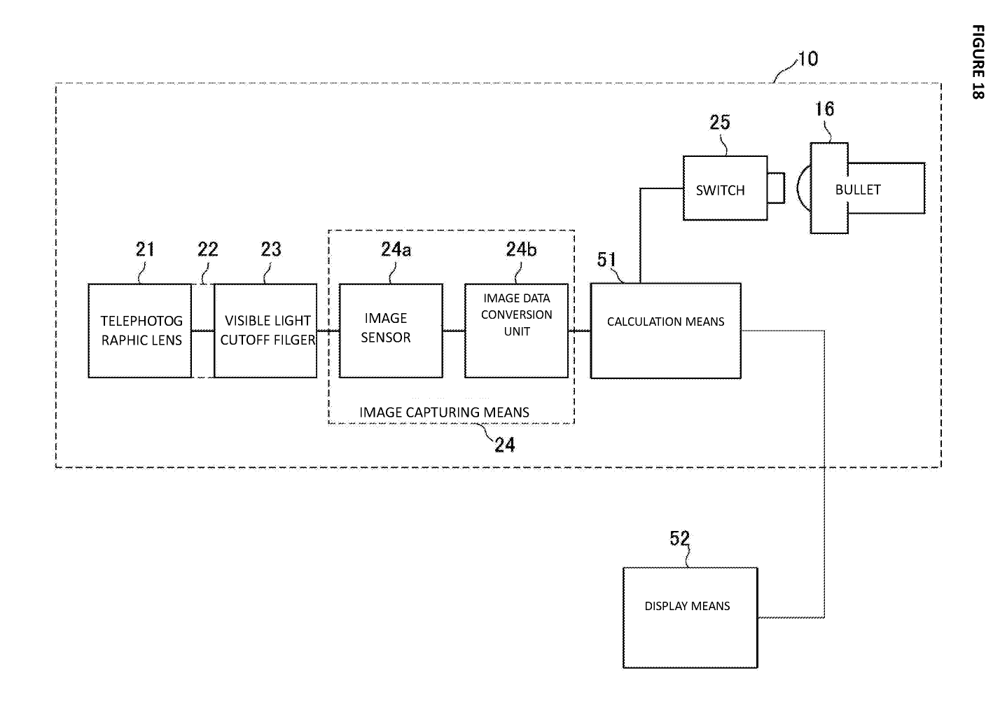

### DESCRIPTION OF PREFERRED EMBODIMENTS

A first embodiment of a shooting system according to the present invention will be described below with reference to the drawings.

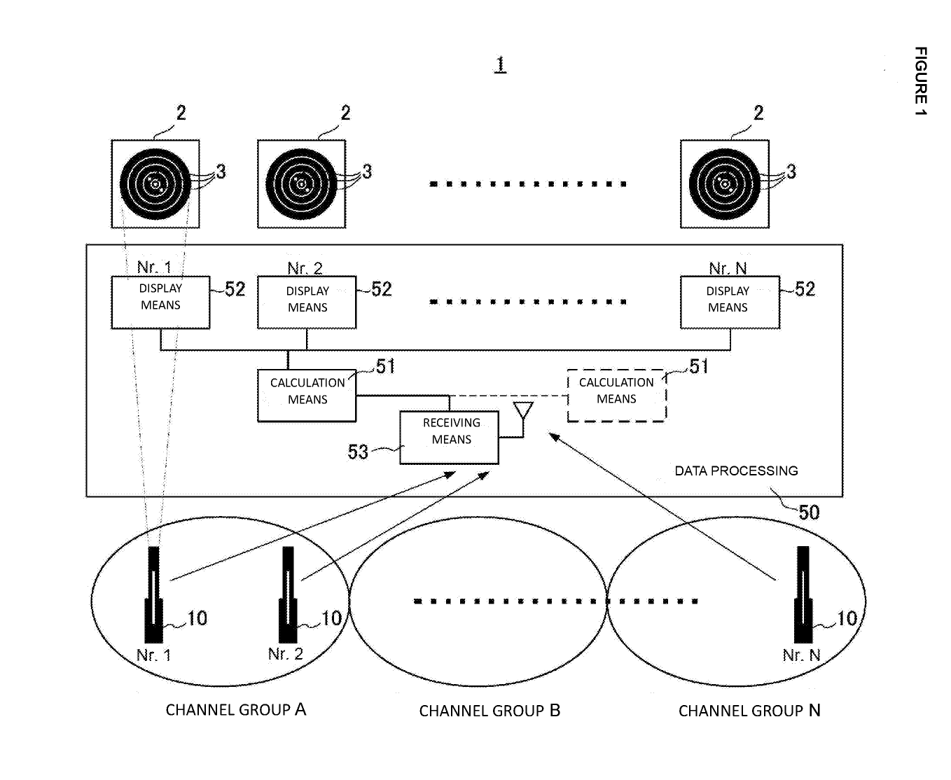

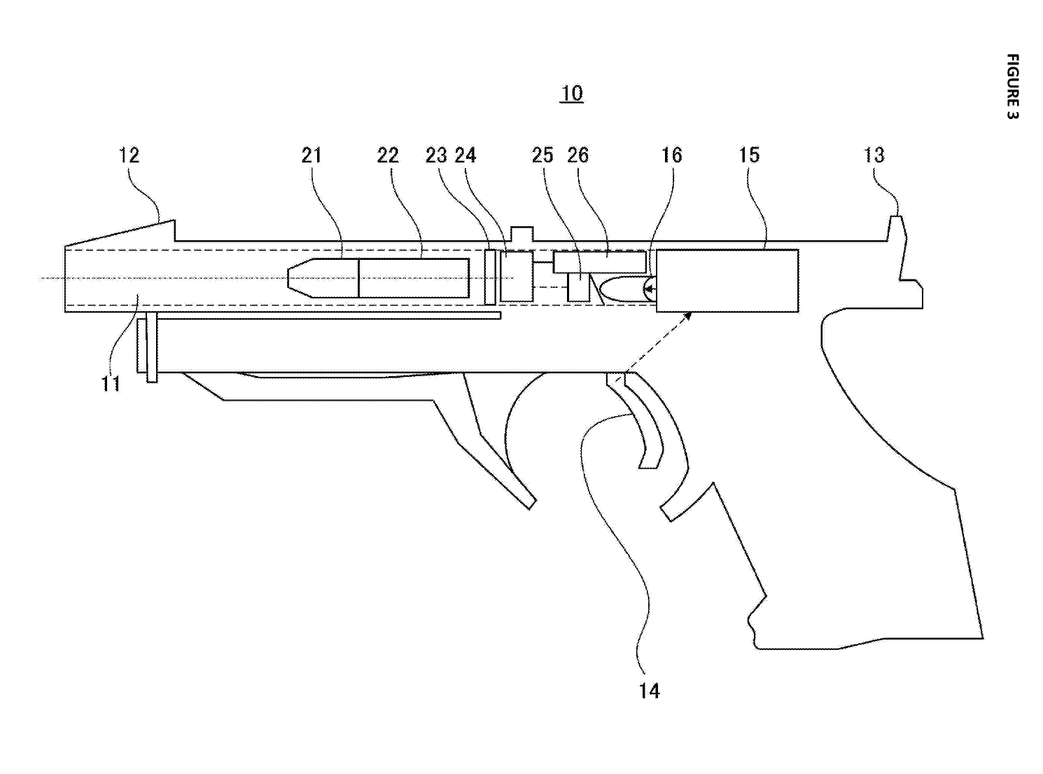

In FIG. 1, a shooting system 1 schematically includes a target 2 having a plurality of infrared LEDs (infrared light emitting means) 3 mounted thereon, a gun (see FIG. 3) loaded with image capturing means (a camera) 24, and a data processing device 50 which acquires an image captured by the image capturing means 24 and calculates a bullet landing position.

A configuration of the shooting system 1 according to the present embodiment will be described in detail below.

(Configuration of Target)

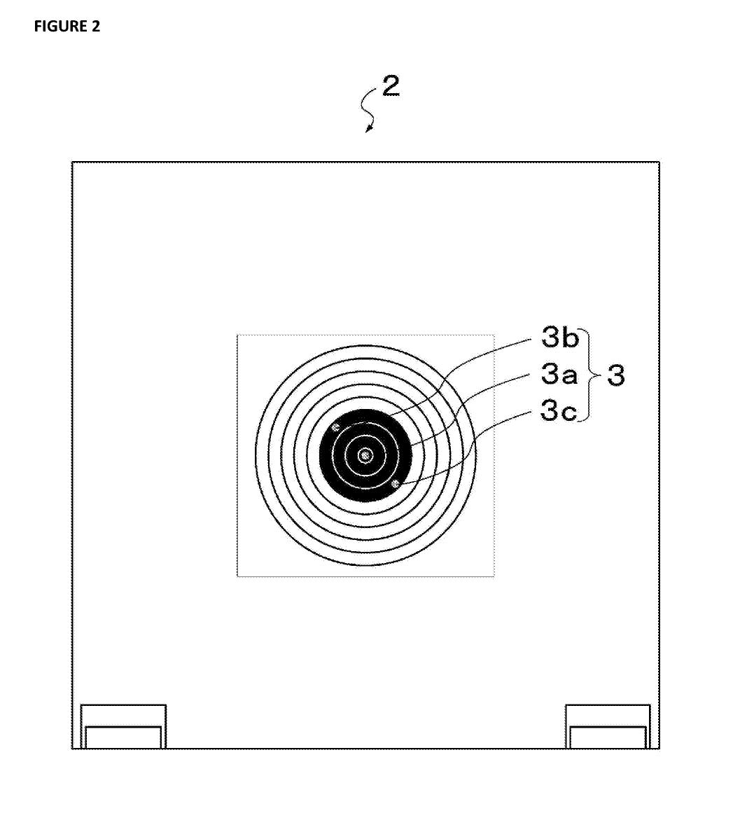

An example of an arrangement on the target 2 of the infrared LEDs 3 mounted on the target is illustrated in FIG. 2.

An infrared LED 3a is mounted at the center of the target having a concentric score region, and two infrared LEDs 3b and 3c are further mounted on a straight line passing through the center of the target. The infrared LEDs 3b and 3c are preferably arranged at an equal distance on the straight line with the infrared LED 3a on the target 2 sandwiched therebetween.

A light emitting portion of each of the infrared LEDs (3a to 3c) mounted on the target is exposed from a hole provided at a position of the infrared LED 3. Therefore, an image can be captured by the image capturing means 24 in the gun 10.

Among the infrared LEDs 3 (3a to 3c) on the target, the LEDs at both ends may be arranged not on vertical and horizontal lines but obliquely to enable confirmation that a video image of the target is not reversed in vertical and horizontal directions when it is seen by the data processing device 50.

(Configuration of Gun)

A configuration of the gun according to the present embodiment will be described below with reference to FIG. 3. The type of the gun is not limited to that in the present embodiment, and may be a pistol, for example, or may be a rifle or the like.

The gun 10 has image capturing means 24 mounted in a gun barrel 11 in its gun body, has a visible light cutoff filter 23 attached on its front side (on the side of its gun muzzle), and is provided with a telephotographic lens 21 via a lens cylinder 22. Each of the means 21 to 24 may be aligned with a cavity of the gun barrel and its central axis.

A specification for this visible light cutoff filter 23 can be determined depending on a specification for the infrared LED 3 on the side of the target 2. If an LED having a peak wavelength of 940 nm is adopted as the infrared LED on the side of the target, a visible light cutoff filter, which cuts a wavelength of less than 920 nm, called IR92, is preferably used to correspond thereto.

An attachment position can be varied, as needed. For example, the visible light cutoff filter maybe provided at the front. Alternatively, the lens cylinder may be omitted.

Also, the gun 10 includes transmission control means 26 which detects an operation of the switch 25 and transmits image data acquired by the image capturing means 24.

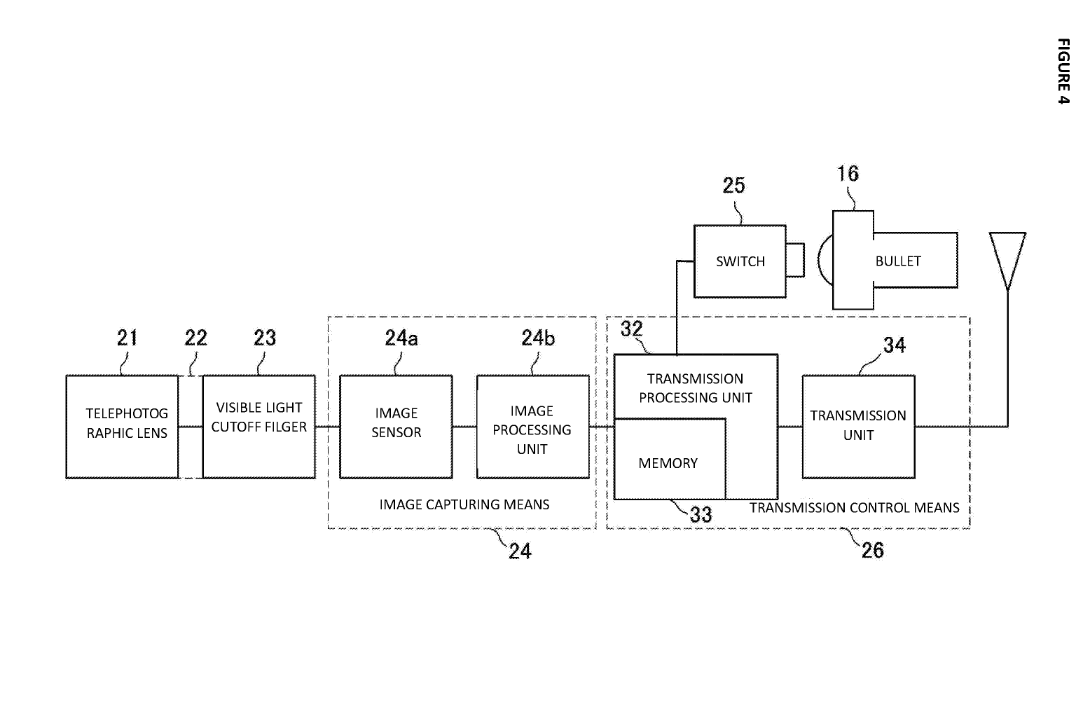

The image capturing means 24 includes an image sensor 24a, and an image processing unit 24b which converts a captured image into image data having a predetermined form, as illustrated in FIG. 4.

The transmission control means 26 includes a transmission processing unit which periodically acquires the image data from the image capturing means 24 and stores the image data in a memory, and a transmission unit which transmits the image data in the memory of the transmission processing unit to the transmission processing device 50.

An example of a function of the image capturing means 24 will be described below.

Examples of this image sensor 24a can include a CCD (Charge Coupled Device) element and a CMOS (Complementary Metal Oxide Semiconductor) element. The image sensor 24a delivers a captured image of a predetermined size such as a VGA (Video Graphics Array) size (640×480 pixels) to the image processing unit 24b. The image processing unit 24b generates compressed data in a motion JPEG (Joint Photographic Experts Group) format, for example, from this captured image, and inputs the compressed data to the transmission control means 26. The transmission processing unit 32 in the transmission control means 26 sequentially writes, when it accepts the image data from the image processing unit 24b, the image data into the memory 33. An example of this memory includes a circulation memory. When a predetermined amount of data is written into the memory, the data may be sequentially overwritten.

The transmission processing unit 32 inputs an operation signal of a switch 25, detects that the switch 25 is turned on, and sends the newest image data stored in the memory to the data processing device 50 by wireless communication such as Wi-Fi (Wireless Fidelity) (registered trademark, as the case may be) via the transmission unit 34.

(Configuration of Data Processing Device)

The data processing device 50 includes receiving means for receiving the image data transmitted from the transmission control means 26 in the gun 10, calculation means 51 for calculating a distance from the gun to the target and a bullet landing position on the target using the received image data, and display means 52 for displaying a calculation result, as illustrated in FIG. 1. The means 51 to 53 are connected to one another via communication means such as a LAN (Local Area Network) or a USB (Universal Serial Bus).

This data processing device 50 can be implemented using a general personal computer loaded with a wireless communication function such as Wi-Fi.

An operation of the shooting system according to the present embodiment will be described below mainly with reference to FIGS. 1 and 2. A shooter serving as a user of this system 1 aims at the target 2 using the gun 10. As illustrated in FIGS. 3 and 4, the transmission control means 26 loaded into the gun 10 always periodically accepts image data of the target from the image capturing means 24, and writes the accepted image data into the memory 33. When the shooter pulls a trigger 14 in the gun 10 in this state, a bullet 16 fired by the firing mechanism 15 presses and turns on the switch 25. The transmission processing unit 32 in the transmission control means 26 transmits the newest image data stored in the memory 33 via the transmission unit 34 when it detects that the switch 25 has been turned on.

The firing mechanism 15 is according to a conventional technique. An example is a system for firing the bullet 16 with a force of air. However, another system can also be used.

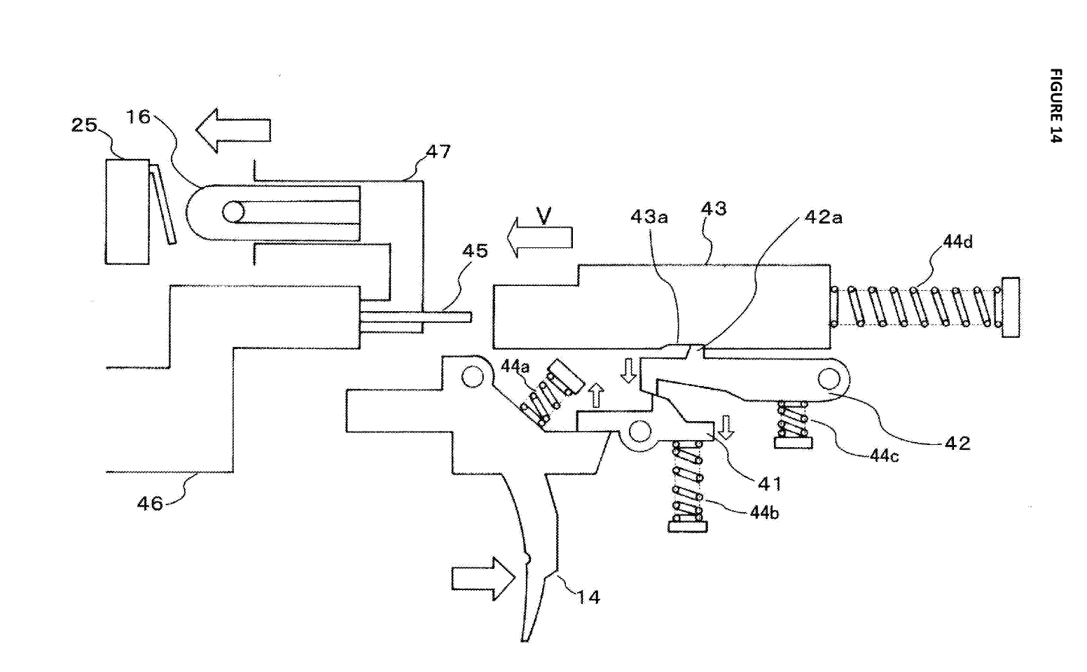

For reference, a system for firing the bullet 16 by a conventional firing mechanism and pressing the switch 25 will be simply described with reference to FIG. 14.

When a shooter pulls a trigger 14, a sear 41 and a sear 42 respectively move in directions of arrows. As a result, a hook 42a of the sear 42 comes off a depression 43a of a striker 43, and the striker 43 moves in a direction indicated by an arrow V with an urging force of a spring 44d, to press a valve 45. This valve 45 assumes a role of a value for opening and closing an area between an air tank 46 and an air conduction pipe 47. However, when the valve 45 is pressed, this valve is opened so that compressed air within the air tank 46 is ejected to the air conduction pipe 47, to extrude a bullet 16. The switch 25 is turned on when its button is pressed by this bullet 16. In FIG. 14, the means 41 to 47 constitute the conventional firing mechanism 15. Respective other ends of springs 44a to 44d are fixed to a gun body.

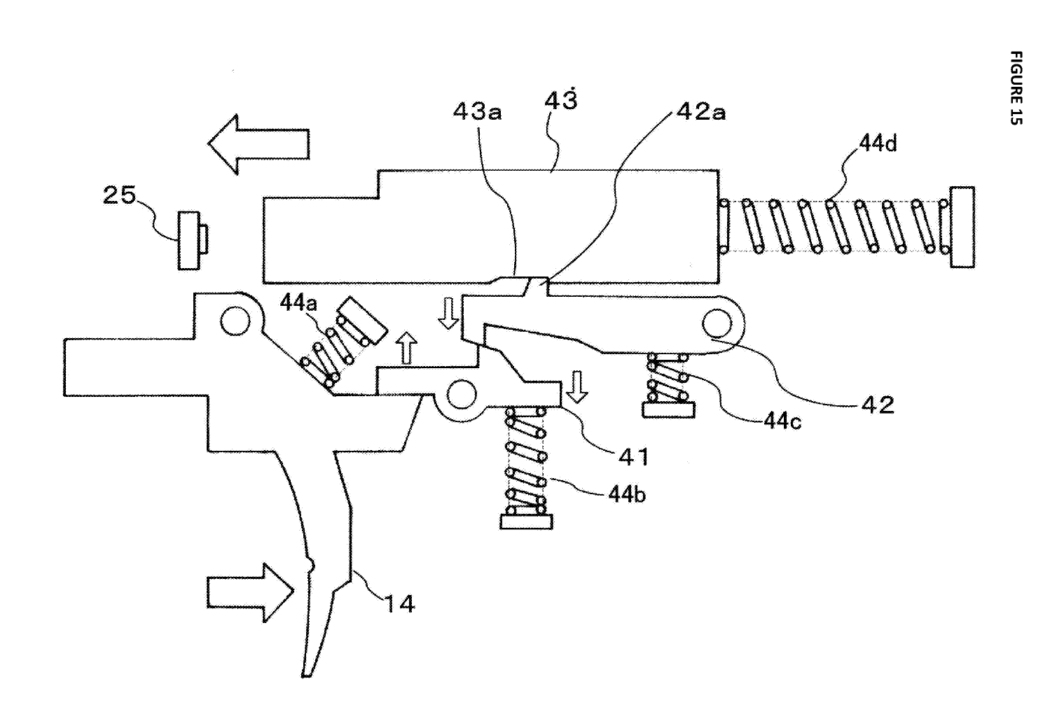

A method for pressing the switch 25 using the conventional firing mechanism 15 is not limited to that illustrated in FIG. 14. For example, a striker 43 may directly press a button of a switch 25, as illustrated in FIG. 15.

In the data processing device 50, when the receiving means 53 receives the image data sent from the transmission control means 26, the calculation means 51 detects respective positions of the infrared LEDs on the target from this image data, calculates a distance from the gun to the target and a bullet landing position on the target based on a spacing between the infrared LEDs, and outputs a result of the calculation to display means 52. Channels are respectively assigned to the guns 10, and the calculation means 51 may perform processing for each group (channel group) assigned the same channel, or may perform processing independently for each of the guns.

A processing content of this calculation means 51 will be described below.

(Method for Searching for Light Spot of LED)

In the gun 10, the telephotographic lens 21 enlarges the target to capture its image, and the calculation means 51 in the data processing device 50 limits a search range of a light spot of an LED within the captured image to a predetermined range to perform processing for detecting the LED. Accordingly, the light spot of the LED can be detected with high accuracy by eliminating the influence of environment light. What is important at this time is that respective images of the plurality of LEDs on this target serving as a detection processing target are captured by simultaneous exposure processing, i.e., at the same exposure timing. This is because respective positions within the image of the LEDs on the target subtly shift for each exposure processing by the influence of environment light (e.g., flicker of illumination or natural light). When the position of each of the LEDs is detected using the image captured at the same exposure timing, the position can be detected with high accuracy by eliminating the influence of environment light.

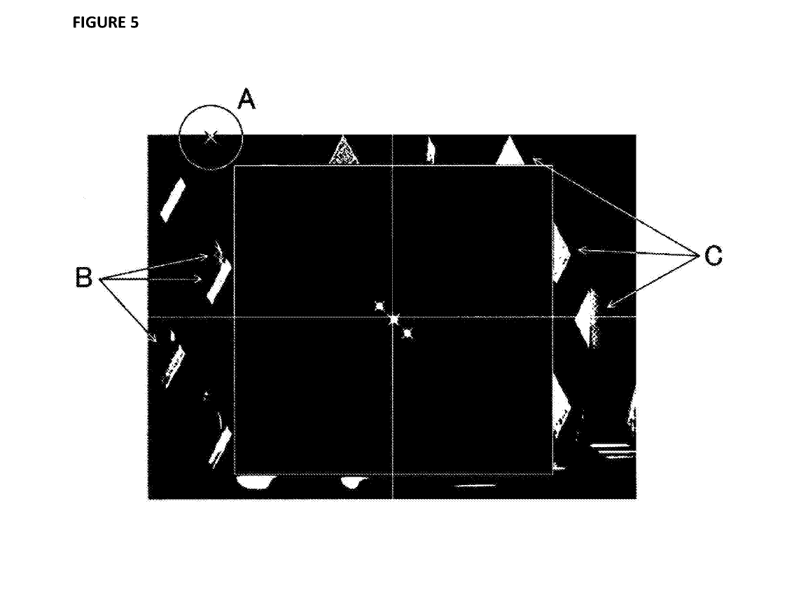

For example, an image illustrated in FIG. 5 is an image captured via the telephotographic lens. However, there is no recognition point other than an original LED on a surface of a target. While there is a recognition point in a place where a background other than the target is bright (a place where luminance is high, e.g., A-C), reflection of environment light can be suppressed by selecting a material for at least the surface of the target. Therefore, the possibility that an unintended recognition point occurs on the surface of the target can be eliminated. To correctly recognize a light spot of the LED, when a difference between the length and the width of the light spot is within a predetermined value (e.g., 16 pixels), it is preferably determined that the light spot is the light spot of the LED. Further, the condition that the light spot is the light spot of the LED when the radius of the light spot is within a range of a previously determined threshold value may be used. Thus, the LED can be detected with high accuracy particularly from a captured image binarized to black and white.

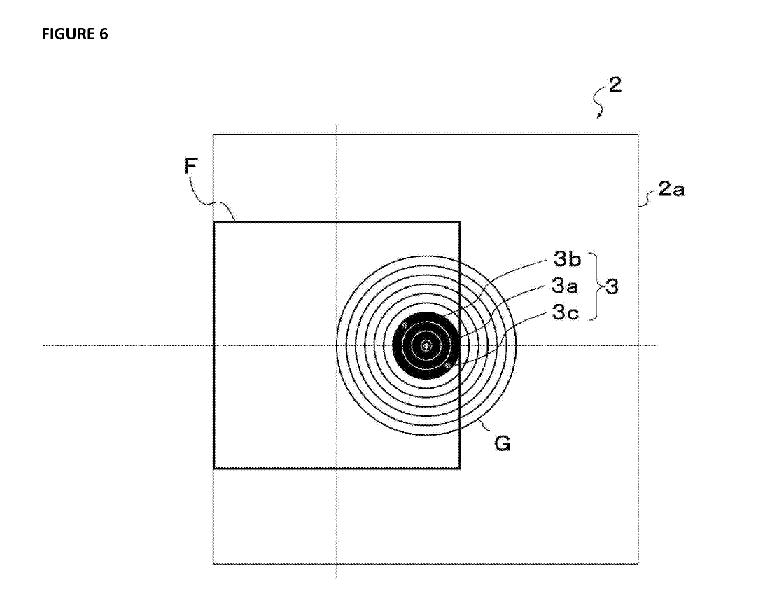

As a specific processing method, when an outermost frame G of concentric circles of the target (usually, a place where a score of zero is obtained; see FIG. 6) is at the center of a screen, respective light spots of three LEDs for distance measurement just fall within a setting range. For the circular entire circumference of the target, the range is thus determined to previously determine the size of a mount of the target 2.

FIG. 6 illustrates an example of image data to be processed by the calculation means 51. In this figure, when an intersection of one-dot and dash lines is set to the center of an image, a frame F corresponds to a search range in amount 2a of the target 2. As a result, even if a place where a score of zero is obtained is at the center of the screen, the frame F falls within a range of the mount of the target. If a group of light spots of LEDs cannot be detected as a result of image processing, it can be determined that a bullet landing position is outside the target, i.e., the score is zero.

(Processing for Calculating Distance from Gun to Target)

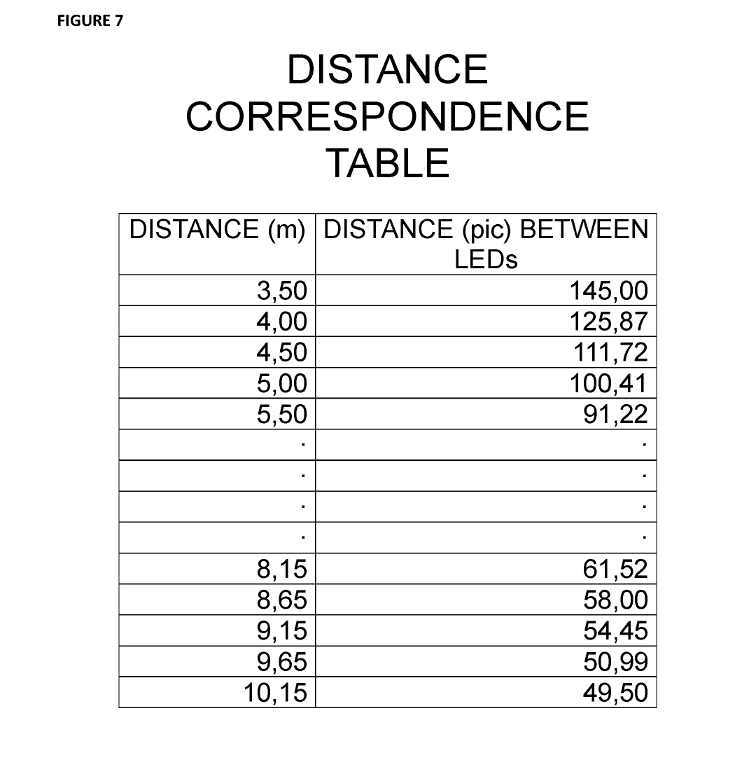

In the present embodiment, a distance correspondence table representing a correspondence relationship between a distance (m) between a gun and a target and the number of pixels between light spots of the LEDs 3b and 3c at both ends (a distance (pic) between LEDs), illustrated in FIG. 7, is previously stored in the calculation means 51, and the distance between the gun and the target is found by referring to the distance correspondence table from a distance between the light spots of the LEDs at both the ends extracted from image data. A calculation example is illustrated below.

Since the light spots of the outside two LEDs among the light spots of the three LEDs are LED light spots for distance calculation, and the light spot of the one LED at the center is the center of an image of the target, a distance (the number of pixels) between the outside two light spots is calculated at first. Then, a distance (d) to the target is calculated using the distance correspondence table.

Letting 1.5 m=A dots, 2.0 m=B dots, and 2.5 m=C dots, for example, in the distance correspondence table, if the distance d satisfies B<d<C, the distance d can be calculated from the following equation:

Distance=(d−B)/(C−B)*(2.5−2.0)+2.0

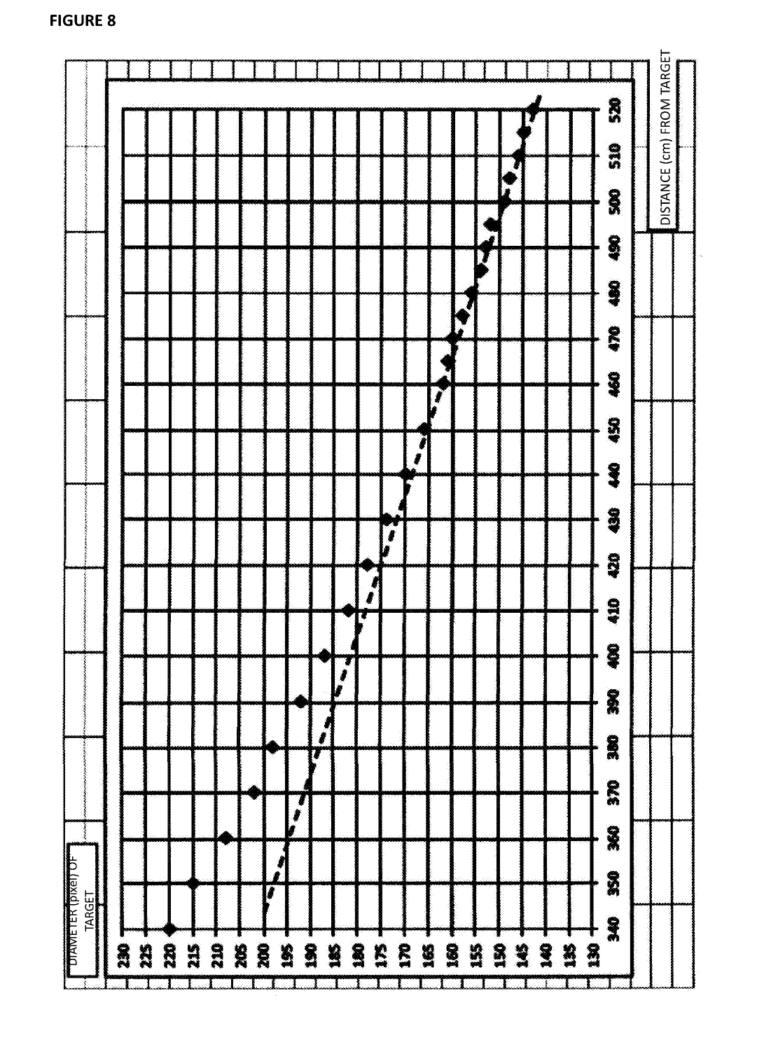

If an image of the target is captured via the telephotographic lens 21 at a relatively close distance, when the distance (the number of pixels) between the light spots of the LEDs is simply multiplied by a coefficient to perform calculation, the accuracy is reduced. This is because a relationship between the distance between the light spots of the LEDs and the distance from the gun (image capturing means) to the target is not linear, as illustrated in FIG. 8. However, according to the aforementioned method, the distance from the gun to the target can be calculated with high accuracy regardless of whether the distance is short or long.

While the distance between the light spots of the infrared LEDs 3b and 3c at both ends is used in the foregoing, a distance between the light spot of the infrared LED 3a at the center and the light spot of the infrared LED (3b or 3c) at either one of the ends may be used.

(Calculation of Bullet Landing Position)

A method for calculating a bullet landing position will be described below.

The calculation means 51 calculates a distance between the light spots of the outside two LEDs at a standard distance (e.g., 10 m) from the distance relationship table, and calculates the size per pixel.

Letting Ddef be a distance between the light spots of the outside two LEDs at the standard distance, and letting Dreal be a real distance between the two light spots (unit: mm), the following equation holds:

Distance per pixel (unit: mm) PixDis=Dreal/Ddef

An actual score is calculated as:

Distance from center of image to light spot of LED at center=DLED

Distance between two light spots of outside LEDs at that time=Dout

Distance from center (unit: mm)=DLED*PixDis*Dout/Ddef

When a bullet landing point on an image of a target is displayed, letting:

Coordinates within captured image of LED at center: (XLED, YLED)

Center coordinates of captured image: (Xcen, Ycen)

Center coordinates of image of target (Xtrg_c, Ytrg_c)=Wtrag and Htrag divided by two

Distance per pixel of image of target (unit: mm): Dtrg

Bullet landing coordinates within image of target: (Xhit, Yhit),

the bullet landing point can be calculated as:

Xhit=((XLED−Xcen)*PixDis*Dout/Ddef)/Dtrg+Xtrag_c

Yhit=((YLED−Ycen)*PixDis*Dout/Ddef)/Dtrg+Ytrg_c

The foregoing is an example of a calculation equation. Bullet landing coordinates may be found using another geometric method.

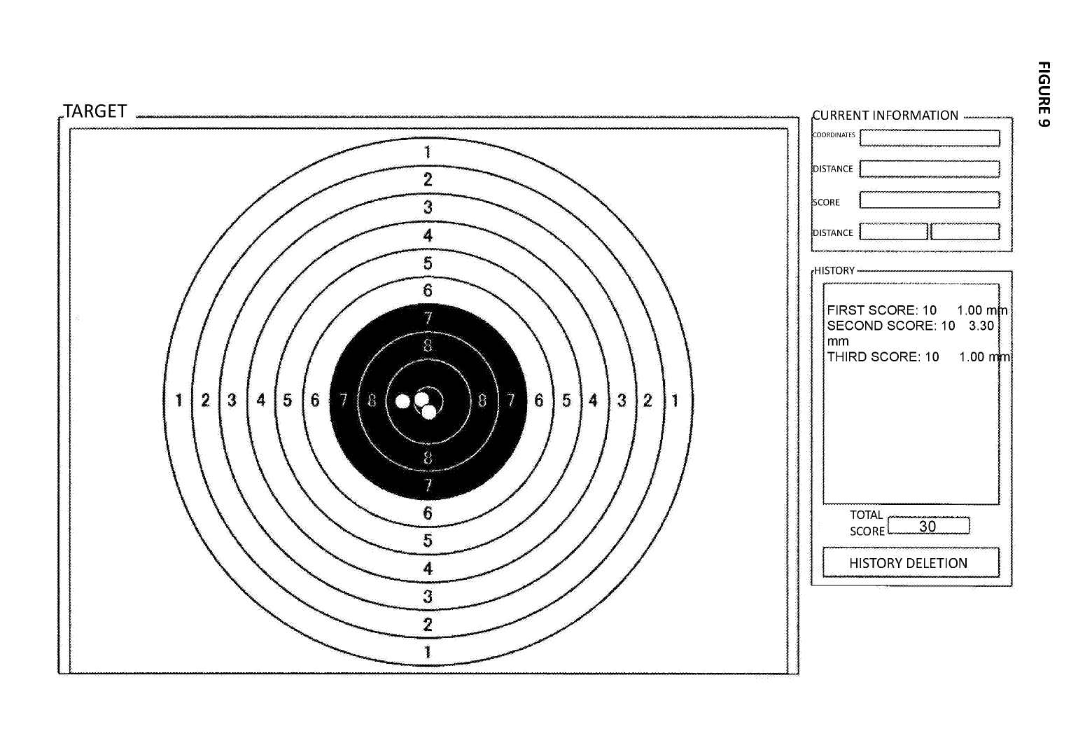

Thus, X and Y coordinates are calculated as the bullet landing point on the image of the target, and a symbol (e.g., ) representing a bullet landing position is displayed on the coordinates. The length of an oblique line is found using a trigonometric function from X and Y dimensions, to determine a score. FIG. 9 illustrates an example of a result display screen output to the display means 52. In this figure, a bullet landing position is symbolically displayed on a target graphically displayed on the display screen, and the newest bullet landing position is displayed for each color. An infrared LED is not displayed. In a current information column, a distance from a gun to the target is displayed in real time. A history of scores and a total score are displayed in a history column. When a history deletion button in the lowest column is selected, information in the history column is cleared.

(Height Correction of Bullet Landing Position)

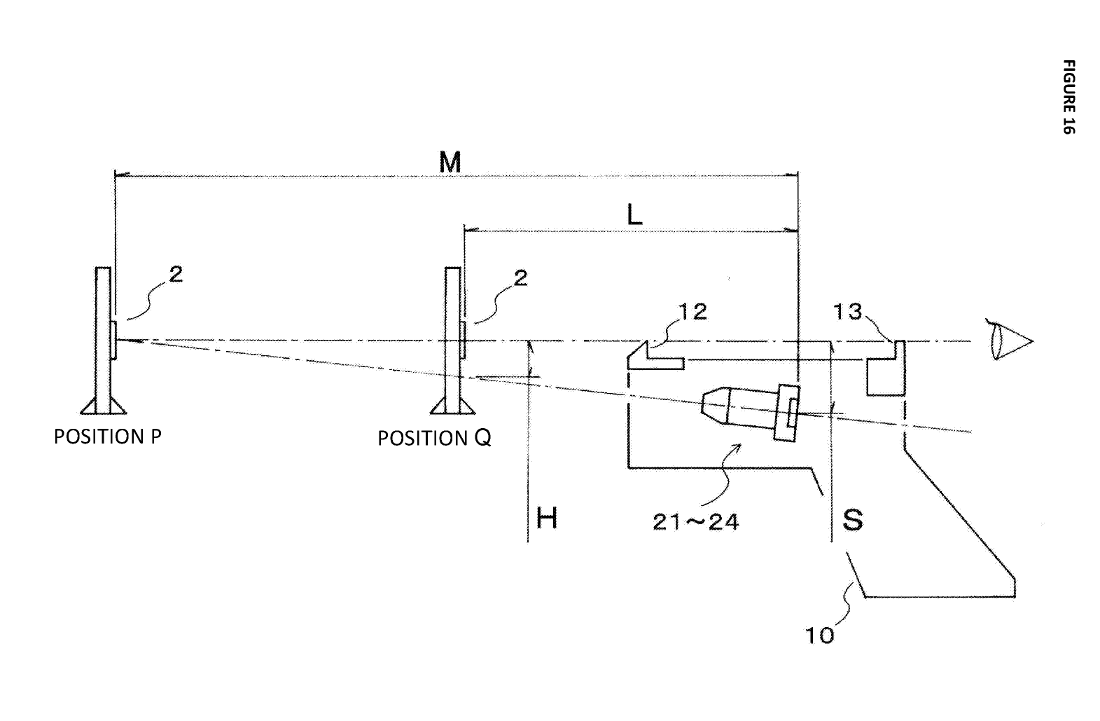

In the case of live firing, a course of a bullet differs depending on a distance from the gun 10 to the target 2. Thus, a bullet landing position is preferably calculated in consideration of an amount of drop of the bullet. Further, according to the present embodiment, respective positions of a gun-sight (a front site 12 and a rear site 13 illustrated in each of FIGS. 3 and 16) and the image capturing means 24 shift from each other in a height direction. Therefore, the gun-sight needs to be rearranged if the distance varies.

In the present embodiment, to resolve inconvenience of this rearrangement, the height direction is corrected depending on the distance. A method for this correction will be described below.

When shots are fired at a position Q (e.g., at home; a distance of 5 m) without changing a gun's sight set during shooting at a position P (e.g., at a match site, a distance of 10 m), as illustrated in FIG. 16, a bullet landing position is below a target. Therefore, a correction value H used when the gun's sight set at the position P is used in shooting at the position Q is found by the following equation:

H=(M−L)·S/M

Here, M is a distance from the gun (image capturing means) to the position P, L is a distance from the gun (image capturing means) to the position Q, and S is a distance from a line of sight (a line connecting the front site and the rear site) to the center of a captured image (image sensor).

As illustrated in the figure, if the distance M>the distance L, the center of the captured image is below an aimed position. Therefore, in the aforementioned calculation of the bullet landing position, the correction value H (positive value) is added to Y coordinates (YLED) within a captured image of the LED at the center, to perform the subsequent processing. On the other hand, if the distance M<the distance L, the center of the captured image is above the aimed position. Therefore, in the aforementioned calculation of the bullet landing position, a correction value H (negative value) is added to the Y coordinates (YLED) within the captured image of the LED at the center, to perform the subsequent processing. When the distance M=the distance L, the correction value H becomes “zero”.

The distance M is set in the calculation means 51 in the data processing device 50 by the user, and a value of the distance between the gun and the target, which has been calculated by the calculation means 51, can be used as the distance L. The length S may be set by the user depending on the type of the gun to be used, or may be previously registered in the data processing device.

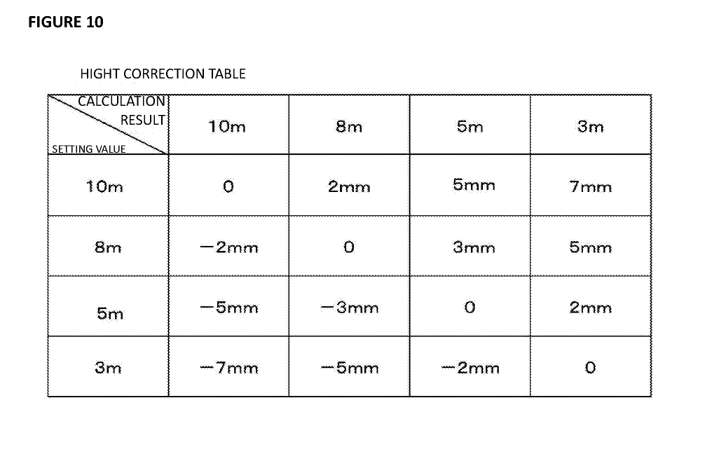

The correction value H can also be found using a correction table illustrated in FIG. 10 instead of the aforementioned calculation. This height correction table is previously registered in the calculation means 51. In the correction table, a row indicates a setting value of a distance registered in the calculation means 51 by the user, and a column indicates a distance between the gun and the target calculated by the calculation means 51 after shooting by the user.

If a gun whose gun's sight has been set at a distance of 10 m by the user is used at another distance (e.g., 5 m), for example, the user sets 10 m in the calculation means 51.

If the calculation means 51 determines that the distance between the gun and the target is 5 m from a spacing between the light spots of the LEDs in the image data sent after shooting by the user, the calculation means 51 accesses the height correction table, to extract a value (5 mm) at an intersection of the row (10 m) and the column (5 m) and add the extracted value to the Y coordinates (YLED) within the captured image of the LED at the center as a correction value, to perform the subsequent processing.

By this correction processing, the user need not readjust the gun-sight for each of matches or trainings in environments which differ in distance. Therefore, convenience for the user is improved.

As described above, according to the present embodiment, the one infrared LED is provided at the center of the target, the two LEDs are further arranged on both sides with the LED at the center sandwiched therebetween on a straight line passing through the center, and the target is enlarged to capture its image by the telephotographic lens, the visible light cutoff filter, and the image capturing means provided within the gun barrel. Further, in the data processing device, the search range is narrowed down, to detect the light spots of the LEDs. Therefore, the light spots can be detected with high accuracy by eliminating the influence of environment light. Thus, the bullet landing position can be calculated with high accuracy.

When the height direction is corrected based on the distance set by the user and the distance between the gun and the target serving as a calculation result by the calculation means, convenience for the user is improved.

The present invention is not limited to the aforementioned embodiment, and can be implemented by varying the present invention without departing from the scope of the invention. Modified examples will be described below.

(Modified Example of Target)

While the target is provided with the three infrared LEDs in the present embodiment, this can be implemented if there are at least two infrared LEDs in a place where there is little influence of environment light. In this case, the infrared LED at the center on the target is removed, and only the infrared LEDs on both sides provided at an equal distance from the center are provided. An intermediate point between both the respective light spots of the LEDs may be the center of the target.

The infrared LEDs 3b and 3c at both ends can be made less noticeable when they are arranged within a black circle. However, if this is difficult from conditions such as the resolution of the captured image, the infrared LEDs 3b and 3c are preferably arranged on the circumference of any one of concentric circles.

(Modified Example of Gun)

If there is no practical problem with the processing capability and the wireless communication speed of the transmission control means 26, a portion (a target portion and its periphery) of an image captured by the image capturing means 24 having a high resolution may be enlarged and processed instead of being optically enlarged by the telephotographic lens 21. On the other hand, if the telephotographic lens 21 is used, a distance between a gun and a target is preferably found from a spacing between respective light spots of LEDs by referring to a distance correspondence table.

In the present embodiment, the shooting mechanism 15 moves the bullet 16 by pulling the trigger 14 to press the switch 25, or the striker 43 in the shooting mechanism 15 directly presses the switch 25. However, one feature of the present invention is to operate the switch 25 using the conventional shooting mechanism 15. The present invention is not limited to the aforementioned embodiment. For example, when the trigger 14 is pulled by setting the type of the striker 43 illustrated in FIG. 15 to the type of a firing pin, the switch 25 may be pressed by the firing pin which comes off a sear and advances by a spring.

While the captured image is always stored in the memory 33 on the side of the gun 10 and the newest image stored in the memory 33 is transmitted when the switch 25 has operated in the aforementioned embodiment, the captured image may be acquired and transmitted when power is supplied to the image capturing means 24 by the operation of the switch 25 and a shutter of the image capturing means 24 operates.

While the captured image is transmitted after being converted into a motion JPEG (Joint Photographic Experts Group) in the image capturing means 24 according to the aforementioned embodiment, only a luminance value (Y value) of the captured image may be transmitted instead of the motion JPEG. Alternatively, a threshold value for black and white determination may be stored in the memory of the gun 10 to compress and transmit an image which has been binarized to black and white. Accordingly, a response time can be more improved by reducing an amount of data transmission.

While wireless communication with Wi-Fi is used between the gun 10 and the data processing device 50 in the aforementioned embodiment, another communication means such as Bluetooth (registered trademark) may be used.

(Modified Example of System Configuration)

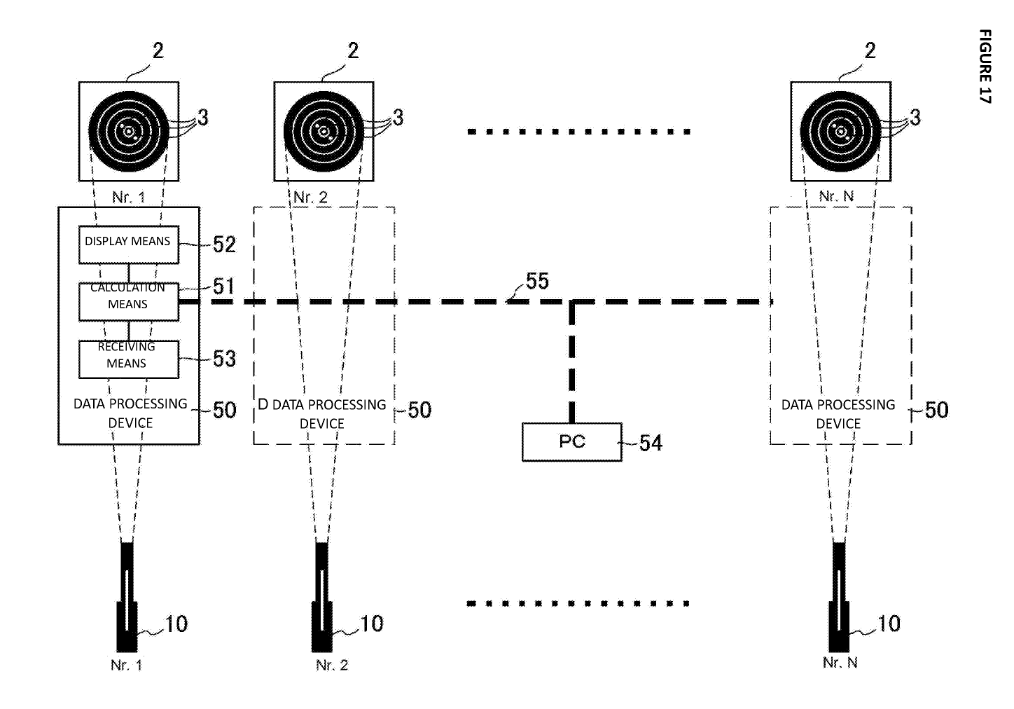

In FIG. 1, the receiving means 53 receives image data sent from the plurality of guns 10, and the one or two or more calculation means 51 perform data processing in response to a calculation load. However, a data processing device 50 including receiving means 53, calculation means 51, and display means 52 may be allocated for each pair of a target and a gun, as illustrated in FIG. 17. In this case, the calculation means 51 may be preferably connected to one another in a shooting competition or the like so that a match result is seen by a personal computer (PC) 55 for a player.

Furthermore, calculation means 51 for detecting an operation of a switch to detect respective light spot positions of infrared LEDs from image data acquired by image capturing means 24 and calculating a distance from a gun to a target and a bullet landing position on the target based on the light spot positions may be provided on the side of the gun 10, to send a result of this calculation to display means 52 by wire or wireless and display the calculation result.

### EXAMPLE

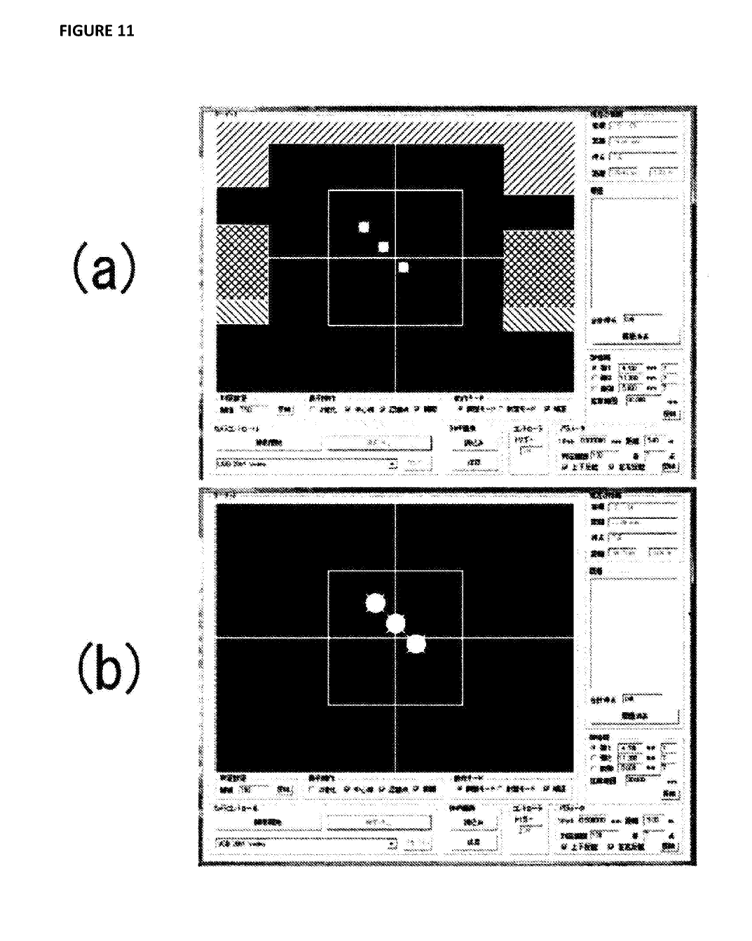

In this example, a shell-type infrared LED having a peak wavelength of 940 nm was adopted on the side of a target, and a visible light cutoff filter, which cuts a wavelength of less than 920 nm, called IR92, was used on the side of a gun to correspond thereto. FIG. 11(a) illustrates an image captured outdoors. It is found that respective three light spots of LEDs have been correctly detected. A background of the target is reflected by light having a wavelength of 920 nm or more included in solar light. To cut this background, it is effective to limit a search range of the light spots of the LEDs to a score frame of the target.

An image illustrated in FIG. 11(b) is an image captured by bringing the same preproduction environment as that illustrated in FIG. 11(a) into a house. The inside of the house (room) is less affected by light rays having a wavelength of 920 nm or more included in solar light. Therefore, the image is darker than that illustrated in FIG. 11(a). A light spot was found to look larger than that outdoors (FIG. 11(a)) by a brightness adjustment function of image capturing means 24. However, if processing for figuring out the center of each of light spots of a group of three LEDs is performed, each of the light spots may be increased unless the light spots are stuck together.

### ANOTHER EXAMPLE

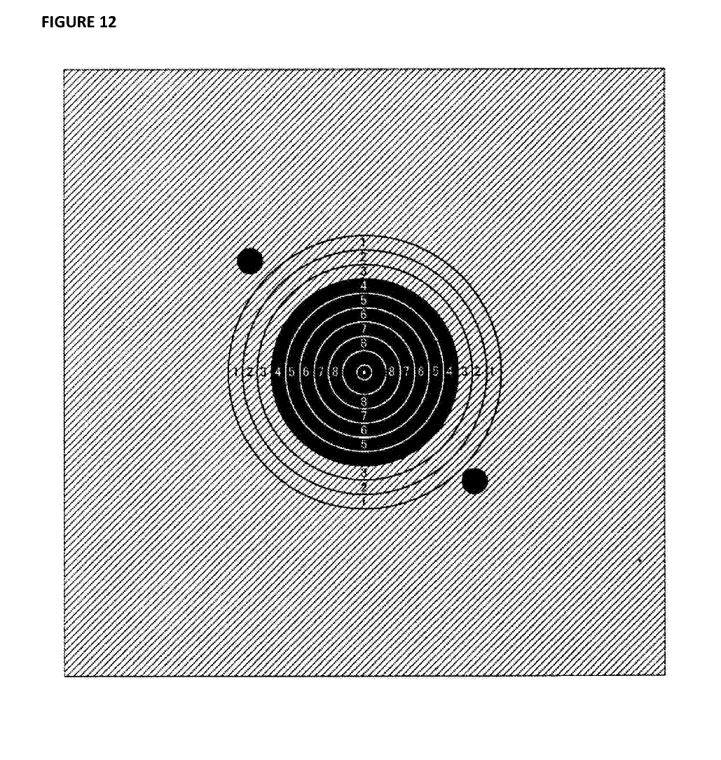

FIG. 12 illustrates a target for a rifle using a chip-type LED having a peak wavelength of 950 nm as an infrared LED. Since a target is small, LEDs at both ends are arranged outside concentric circles.

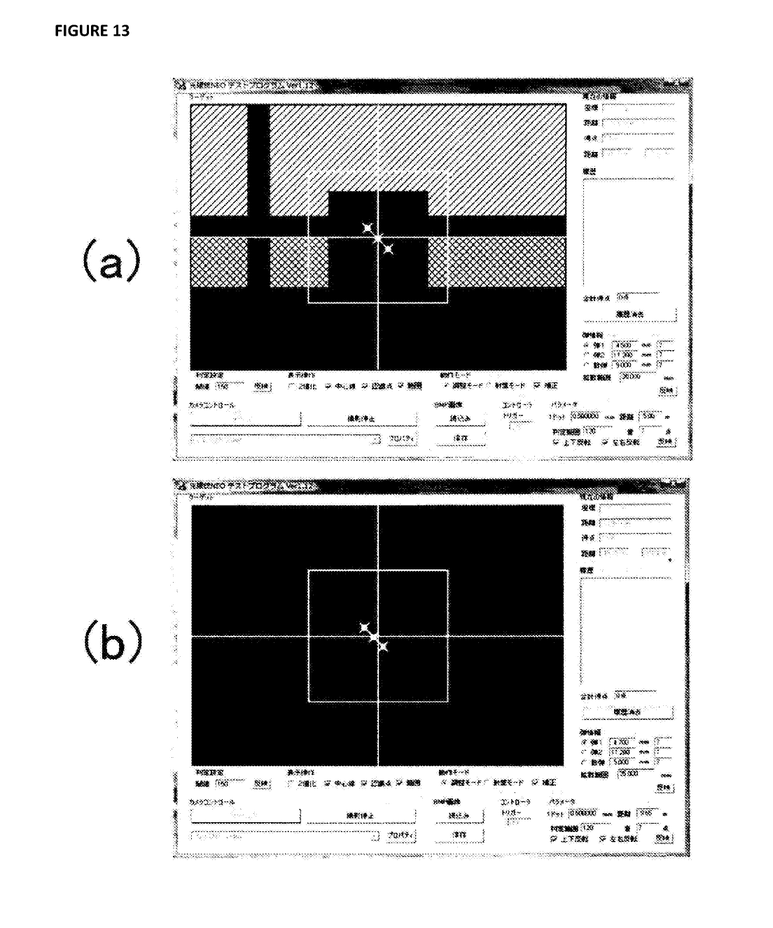

FIG. 13 illustrates an image of a target captured with a rifle using a visible light cutoff filter called IR92. FIG. 13(a) illustrates an image captured outdoors, and FIG. 13(b) illustrates an image captured indoors. An entire screen becomes bright because of near infrared rays included in solar rays outdoors, and a light spot of an LED becomes smaller than that indoors by a brightness adjustment function of image capturing means. However, this is sufficient to accurately detect the LED on the side of a data processing device both outdoors and indoors.

The present invention is not limited to the aforementioned embodiment, and can be implemented by varying the invention without departing from the scope thereof. For example, it is needless to say that if the gun 10 and the data processing device 50 respectively have calculation functions, the calculation functions can be separated, as needed. Particularly if the gun 10 and the data processing device 50 are connected to each other by wireless communication, the aforementioned calculation functions may be separated from the viewpoint of reduction in a transmission load and optimization of a response performance.

### INDUSTRIAL APPLICABILITY

The present invention can be utilized for a practical shooting system. A bullet landing position can be determined with significantly high accuracy. Therefore, a shooting match can be conducted without using real bullets. A training at the same level as that in shooting using real bullets can be conducted.

The present invention can be utilized for a shooting game. A bullet landing position can be determined with high accuracy using an infrared LED instead of a laser and at a resolution close to that of a commercially available camera. Therefore, the present invention can be provided as a low-cost and safe shooting game.

### REFERENCE SIGNS LIST

1 Shooting system
2 Target
2a Mount
(3a, 3b, 3c) Infrared LED (infrared light emitting means)
10 Gun
11 Gun barrel
12 Front site
13 Rear site
14 Trigger
15 Firing mechanism
16 Bullet
21 Telephotographic lens
22 Lens cylinder
23 Visible light cutoff filter
24 Image capturing means
24a Image sensor
24b Image processing unit
25 Switch
26 Transmission control means
32 Transmission processing unit
33 Memory
34 Transmission unit
41, 42 Sear
42a Hook
43 Striker
44a to 44d Spring
45 Valve
46 Air tank
47 Air conduction pipe
50 Data processing device
51 Calculation means
52 Display means
53 Receiving means

1. A shooting system comprising:
a target including two or more infrared light emitting means;
a gun having image capturing means for capturing an image of the target via a visible light cutoff filter provided in its gun barrel, and further including a switch which operates in conjunction with movement of a trigger and transmission control means for transmitting image data acquired by the image capturing means when the switch operates; and
a data processing device including receiving means for receiving the image data sent from the transmission control means, calculation means for detecting a light spot position of each of the infrared light emitting means from the image data and calculating a distance from the gun to the target and a bullet landing position on the target based on the light spot position, and display means for displaying a result of the calculation.

2. A shooting system comprising:
a target including two or more infrared light emitting means;
a gun having image capturing means for capturing an image of the target via a visible light cutoff filter provided in its gun barrel, and further including a switch which operates in conjunction with movement of a trigger and calculation means for detecting a light spot position of each of the infrared light emitting means from image data acquired by the image capturing means when the switch operates and calculating a distance from the gun to the target and a bullet landing position on the target based on the light spot position; and
display means for displaying a result of the calculation.

3. The shooting system according to claim 1, wherein
the target is a target having a concentric score region, the infrared light emitting means being arranged at the center of the target, and the infrared light emitting means being further respectively arranged on both sides with the infrared light emitting means at the center sandwiched therebetween on a virtual straight line passing through the center of the target, and
the calculation means determines that the light spot position of the infrared light emitting means at the center among the detected respective light spot positions of the infrared light emitting means is the center of the target, calculates the distance from the gun to the target based on a spacing between the light spot positions of either two of the infrared light emitting means, and calculates the bullet landing position based on the distance and a result of the determination.

4. The shooting system according to claim 1, wherein the calculation means corrects a height direction of the bullet landing position based on the distance from the gun to the target serving as the result of the calculation.

5. The shooting system according to claim 1, wherein the switch in the gun operates by a bullet, a firing pin, or a striker which moves when a trigger is pulled.

6. The shooting system according to claim 1, wherein
the gun further has a telephotographic lens provided in its gun barrel, and
the calculation means includes a distance correspondence table representing a correspondence relationship between the distance from the gun to the target and a spacing between the light spots of the two different infrared light emitting means, and calculates the distance from the gun to the target by referring to the distance correspondence table.

7. A gun having image capturing means, which captures an image of a target including infrared light emitting means via a visible light cutoff filter, provided in its gun barrel, further comprising
a switch which operates in conjunction with movement of a trigger, and
means for generating transmission data for displaying a bullet landing position on the target on display means based on a light spot position of the infrared light emitting means in image data acquired by the image capturing means when the switch operates.

8. A data processing device comprising detecting, from image data of a target including two or more infrared light emitting means and acquired by image capturing means in a gun, a light spot position of each of the infrared light emitting means, and calculating a distance from a gun to a target and a bullet landing position on the target based on the light spot position.

9. The shooting system according to claim 2, wherein
the target is a target having a concentric score region, the infrared light emitting means being arranged at the center of the target, and the infrared light emitting means being further respectively arranged on both sides with the infrared light emitting means at the center sandwiched therebetween on a virtual straight line passing through the center of the target, and
the calculation means determines that the light spot position of the infrared light emitting means at the center among the detected respective light spot positions of the infrared light emitting means is the center of the target, calculates the distance from the gun to the target based on a spacing between the light spot positions of either two of the infrared light emitting means, and calculates the bullet landing position based on the distance and a result of the determination.

10. The shooting system according to claim 2, wherein the calculation means corrects a height direction of the bullet landing position based on the distance from the gun to the target serving as the result of the calculation.

11. The shooting system according to claim 2, wherein the switch in the gun operates by a bullet, a firing pin, or a striker which moves when a trigger is pulled.

12. The shooting system according to claim 2, wherein
the gun further has a telephotographic lens provided in its gun barrel, and
the calculation means includes a distance correspondence table representing a correspondence relationship between the distance from the gun to the target and a spacing between the light spots of the two different infrared light emitting means, and calculates the distance from the gun to the target by referring to the distance correspondence table.
